(19) United States
(12) Patent Application Publication
(10) Pub. No.: US 2012/0147867 A1
(43) Pub. Date: Jun. 14, 2012

(54) SERVERLESS MULTICAST VOICE ENHANCED BARCODE SCANNER ARCHITECTURE

(75) Inventors: Kaustubh Kale, Tamarac, FL (US); Slawomir M. Zakrzewski, Melville, NY (US)

(73) Assignee: Motorola, Inc., Schaumburg, IL (US)

(21) Appl. No.: 12/967,480

(22) Filed: Dec. 14, 2010

(51) Int. Cl. H04W 4/00

(52) U.S. Cl. 370/338

(57) ABSTRACT

A mobile device is described that includes a control for activating a function of the mobile device. The function includes a Push-to-Talk function and/or a Push-to-Scan function of the mobile device. A processor executes the function when the control is activated. A transceiver is coupled to the processor. The transceiver is capable of communicating with at least one networked device over a local area network using voice over internet protocol (VoIP). A memory is coupled to the processor for storing instructions to execute the function by the processor. The processor executes the Push-to-Talk function in a first mode of operation and the Push-to-Scan function in a second mode of operation. The mobile device is part of a system that is also described. The system consists of a VoIP Push-to-Talk infrastructure, either server based or serverless. The mobile device described provides Push-to-Scan functionality over the existing VoIP infrastructure.

### TECHNICAL FIELD

The invention relates generally to voice and data communications between mobile data capture devices.

### BACKGROUND

Mobile data capture devices having Push-to-Talk (PTT) functionality can communicate audio data wirelessly with other mobile data capture devices having Push-to-Talk functionality over voice over internet protocol (VoIP) networks. These devices are typically connected over a wireless local area network (WLAN) to a host device that transmits and receives product data related to the data capture functionality of the device. For example, a data capture device typically scans a product barcode and transmits the barcode data to a host over the WLAN. The host includes a database containing the product information and transmits the requested information to the mobile device over the network.

### SUMMARY

In one aspect, the invention is embodied in a mobile device. The mobile device includes a control for activating a function of the mobile device. The function includes at least one of a Push-to-Talk function and a Push-to-Scan function of the mobile device. A processor is coupled to the control. The processor executes the function when the control is activated. A transceiver is coupled to the processor. The transceiver is capable of communicating with at least one networked device over a local area network using voice over internet protocol (VoIP). A memory is coupled to the processor. The memory stores instructions to execute the function by the processor. The processor executes the Push-to-Talk function in a first mode of operation and the Push-to-Scan function in a second mode of operation.

The mobile device can also include a speaker and a microphone for enabling the Push-to-Talk function. The mobile device can also include a data capture device for enabling the Push-to-Scan function. The data capture device can include at least one of a barcode scanner, an imaging device, and a radio-frequency identification (RFID) reader.

In one embodiment, the mobile device also includes a display coupled to the processor for displaying a graphical user interface (GUI). The memory can also include a database for storing product information.

The Push-to-Talk function can include communicating audio data between the mobile device and at least one networked device. The Push-to-Scan function can include communicating product data between the mobile device and at least one networked device.

In one embodiment, the instructions include a request based service application executed in response to activating a function of the mobile device. The request based service application can create a request for a fused scan and voice service application. The request based service application can be executed in response to activating a function of the mobile device. The request based service application can control the Push-to-Talk function and the Push-to-Scan function.

In another aspect, the invention is embodied in a method for executing a Push-to-Talk function in a first mode of operation and a Push-to-Scan function in a second mode of operation of a mobile device. The method includes storing instructions to execute a function of a mobile device. The function includes at least one of a Push-to-Talk function and a Push-to-Scan function of the mobile device. The Push-to-Talk function is executed in a first mode of operation and the Push-to-Scan function is executed in a second mode of operation. Data is communicated by executing the function with at least one networked device over a local area network using voice over internet protocol (VoIP).

In one embodiment, the data includes one of audio data and product data. The data can be generated using a barcode scanner, an imaging device, and/or a radio-frequency identification (RFID) reader. The method can also include displaying a graphical user interface (GUI). The method can also include storing product information.

In one embodiment, the Push-to-Talk function includes communicating audio data between the mobile device and at least one other mobile device. The Push-to-Scan function can include communicating product data between the mobile device and at least one other mobile device.

In one embodiment, the Push-to-Talk function includes communicating audio data between the mobile device and multiple mobile devices using multicast technology. The Push-to-Scan function can include communicating product data between the mobile device and multiple other mobile devices using the existing Push-to-Talk infrastructure.

In one embodiment, the Push-to-Talk function includes communicating audio data between one or many mobile devices using server based VoIP technology and/or serverless based VoIP technology.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 is a front view of a mobile computing device according to one embodiment of the invention.

FIG. 2 is a block diagram illustrating the electronic components of the mobile device of FIG. 1.

FIG. 3 is a block diagram of a Push-to-Scan architecture according to one embodiment of the invention.

FIG. 4 illustrates a graphical user interface (GUI) for a Push-to-Scan application according to one embodiment of the invention.

FIG. 5 illustrates an application-defined Real-time Control protocol (RTCP) APP message according to one embodiment of the invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to conventional Voice over Internet Protocol (VoIP) communications, need not, and are not, described in detail herein.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to systems utilizing networked devices communicating over VoIP networks. In an exemplary embodiment, a mobile device includes a control for activating a function of the mobile device. The function includes at least one of a Push-to-Talk function and a Push-to-Scan function of the mobile device. A processor executes the function when the control is activated. A transceiver is capable of communicating with at least one networked device over a local area network using voice over internet protocol (VoIP). A memory stores instructions to execute the function by the processor. The processor executes the Push-to-Talk function in a first mode of operation and the Push-to-Scan function in a second mode of operation. In the Push-to-Scan mode, a user can scan a product barcode with the mobile device and share the barcode and product information to other users of devices while in a voice Push-to-Talk session without noticing any difference in user experience. Thus, the existing VoIP infrastructure can be leveraged to share product information over the VoIP network.

The networked devices communicating over VoIP networks can be clients or servers. The clients can include wired LAN components or wireless LAN components. The clients may or may not have integrated data capture devices. In one embodiment, the clients that include Push-to-Scan functionality according to the invention can interoperate with other clients that include industry standard multicast IP functionality.

Additionally, various devices in the network could be designed to carry different pieces of information depending on the processing and memory capabilities of the device. For example, devices having minimal storage capacity will not support a large database of information, whereas a device having a large storage capacity can support a large database. In another example, a database that manages employee information such as Punch In/Out times can be resident on one device that is used by a manager. In one embodiment, a standalone PC/server connected to the network could be used to store the information. In one embodiment, a networked cash register can also include the Push-to-Scan functionality and can transmit and receive data from other devices on the network.

In one embodiment, a system can include one or more devices that serve as a repository for storing product information, for example. Each storage device can include Push-to-Scan functionality. For example, the storage device can respond to a multicast request over the existing deployed server-less or server-based VoIP system with the requested product information.

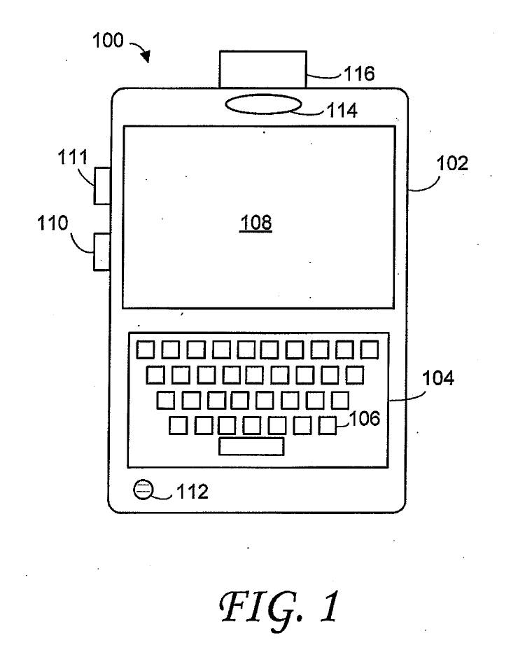

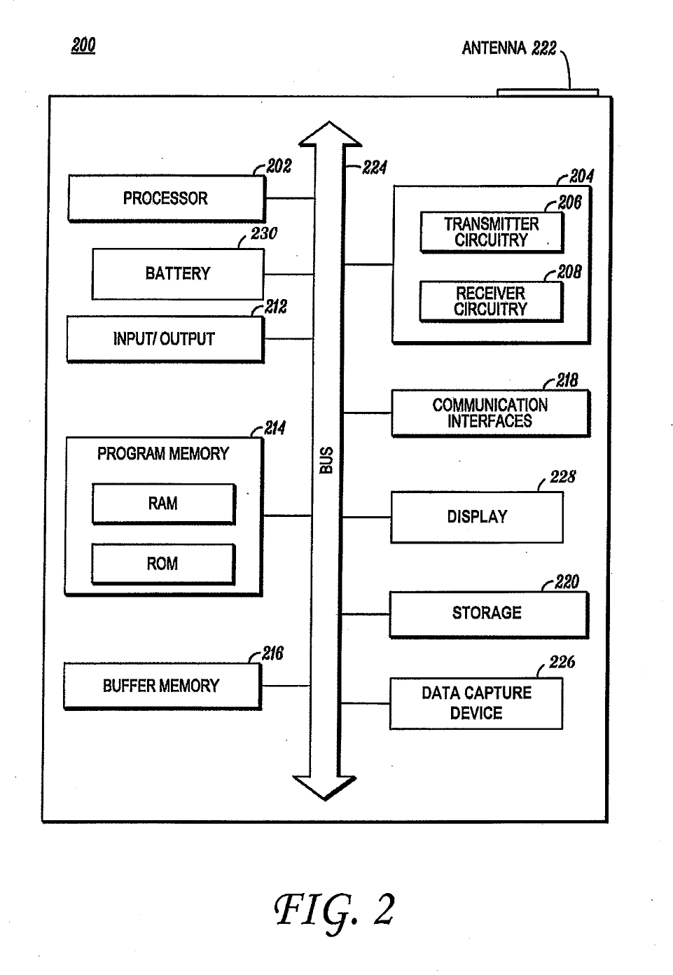

FIG. 1 is a front view of a mobile computing device 100 according to one embodiment of the invention. The mobile computing device 100 is one example of a data capture device having Push-to-Talk functionality according to the invention. The mobile computing device 100 includes a housing 102. The housing 102 contains electronic components, including internal communication components and circuitry as further described with relation to FIG. 2 to enable the device 100 to communicate wirelessly with other devices.

The housing 102 also contains I/O devices such as a keyboard 104 with alpha-numeric keys 106, a display 108 (e.g., LCD) that displays information about the device 100, soft and/or hard keys, Push-to-Scan control switch 110, Push-to-Talk control switch 111, a touch screen, jog wheel, a microphone 112, and a speaker 114. In one embodiment, the Push-to-Scan control switch 110 and the Push-to-Talk control switch 111 are combined into a single control switch.

The mobile computing device 100 can also include a data capture device 116, such as a laser scan engine, an imager and/or a radio-frequency identification (RFID) reader, for capturing data located in a field of view or range of the data capture device 116. In some embodiments, the device 100 includes more or less than all of the I/O devices shown in FIG. 1.

FIG. 2 is a block diagram 200 illustrating the electronic components of the mobile device 100 of FIG. 1 according to the invention. The mobile device 100 contains, among other components, a processor 202, the I/O devices 212 described in relation to FIG. 1, a program memory 214 for storing operating instructions that are executed by the processor 202, a buffer memory 216, one or more communication interfaces 218, and a data capture device 226. The mobile device 100 can also include storage 220 for storing product information and data. The mobile device 100 can also include a display 228 for displaying information and data. In one embodiment, the device 100 includes a battery 230 and a transceiver 204. The transceiver 204 can include transmitter circuitry 206 and receiver circuitry 208. The mobile device 100 is preferably an integrated unit containing the elements depicted in FIG. 2, as well as any other element necessary for the mobile device 100 to function. In one embodiment, the electronic components are connected by a bus 224.

The processor 202 can include one or more microprocessors, microcontrollers, DSPs, state machines, logic circuitry, analog to digital (A/D) converters, hardware digitizers, or any other device or devices that process information based on operational or programming instructions. Such operational or programming instructions are preferably stored in the program memory 214. The program memory 214 can be an IC memory chip containing any form of random access memory (RAM) or read only memory (ROM), a floppy disk, a compact disk (CD) ROM, a hard disk drive, a digital video disk (DVD), a flash memory card or any other medium for storing digital information. Skilled artisans will recognize that when the processor 202 has one or more of its functions performed by a state machine or logic circuitry, the program memory 214 containing the corresponding operational instructions may be embedded within the state machine or logic circuitry. Operations performed by the processor 202 as well as the mobile device 100 are described in detail below.

The transmitter circuitry 206 and the receiver circuitry 208 enable the mobile device 100 to respectively transmit and receive communication signals. In this regard, the transmitter circuitry 206 and the receiver circuitry 208 can include circuitry to enable wireless transmissions. The implementations of the transmitter circuitry 206 and the receiver circuitry 208 depend on the implementation of the mobile device 100 and the devices with which it is to communicate. For example, the transmitter 206 and receiver circuitry 208 can be implemented as part of the communication device hardware and software architecture for communicating over a network using voice over internet protocol (VoIP) technology. One of ordinary skill in the art will recognize that most, if not all, of the functions of the transmitter 206 or receiver circuitry 208 can be implemented in a processor, such as the processor 202. However, the processor 202, the transmitter circuitry 206, and the receiver circuitry 208 have been partitioned herein to facilitate a better understanding of the functions of these elements. In one embodiment, the mobile device 100 can include an antenna 222, such as a wireless local area network (WLAN) antenna coupled to the transceiver 204.

The buffer memory 216 may be any form of volatile memory, such as RAM, and is used for temporarily storing information used by the processor 202, for example. The mobile device 100 can also include the storage device 220. The storage device 220 can be a hard disk, flash, or secure digital (SD) memory card, for example. The storage device 220 can store a database of data related to product information and contact data as will be further described herein.

The data capture device 226 is controlled by the processor 202. The processor 202 issues commands executed by the data capture device 226 via the program memory 214. In one embodiment, the program memory 214 is implemented within a field programmable gate array (FPGA); however the program memory 214 can also be implemented in other devices. The data capture device 226 generates data related to product information captured by the mobile device 100.

In one mode of operation, a user activates a Push-to-Scan control switch 110 on the mobile device 100. The data capture device 226 captures information relating to a target. For example, the data capture device 226 can scan a barcode on the target. Alternatively, the data capture device 226 can include an RFID reader configured to read a radio frequency identification (RFID) tag associated with the target.

The information related to the target can be locally stored in the storage device 220. In that scenario, the information can be displayed on the display 228, for example. The information can also be used for other purposes, such as compiling a product list for check-out or any other purpose. In one embodiment, the information can be stored in another device connected to the network, instead of the storage device 220. In this scenario, the mobile device 100 can send an information request to the other networked devices using a real-time transport (RTP) over a VoIP network. Another device connected to the network containing the information can transmit the information to the mobile device 100. In one embodiment, the information can be updated on the other device if a updated information is available.

In the Push-to-Scan mode, a user can share product information with other users of devices while in a multicast voice Push-to-Talk session. Another user can request information about a product or service from other users in the Push-to-Talk session. The device containing the information can share the information with the requesting device over the VoIP network.

In another mode of operation, a user activates a Push-to-Talk control switch 111 on the mobile device 100. The communication interface 218 invokes walkie-talkie type functionality including activating the microphone 112 and speaker 114 of the mobile device 100. The mobile device 100 can communicate with other devices using a standard Push-to-Talk communication protocol. According to the exemplary embodiments of the invention, the Push-to-Scan functionality is integrated with Push-to-Talk functionality over the VoIP network, thereby creating a similar user experience for both modes of the operation.

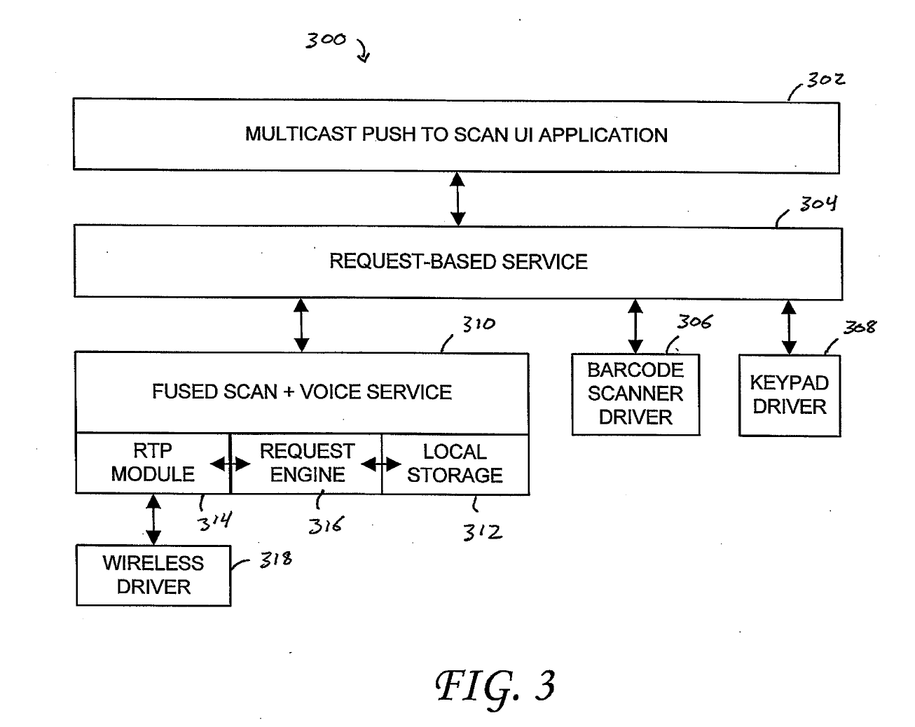

FIG. 3 is a block diagram of a Push-to-Scan system architecture 300 according to one embodiment of the invention. The Push-to-Scan system architecture 300 provides a multicast Push-to-Scan solution over an existing VoIP network.

The Push-to-Scan solution can be implemented on any device, including a fixed or mobile device, having a network stack capable of providing an IP address and can function over a wireless local area network (WLAN). The solution allows a device having a data capture device to interoperate with wireless devices and fixed devices that may or may not include data capture devices.

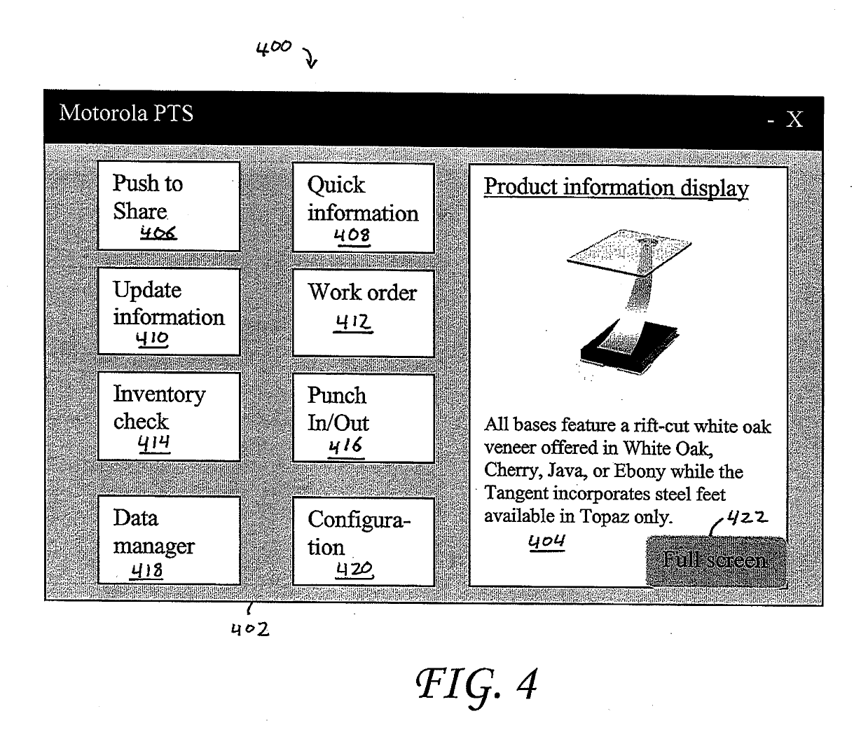

The Push-to-Scan system architecture 300 can include a Multicast Push-to-Scan application 302. The Multicast Push-to-Scan UI application 302 includes a user interface (UI) for permitting the user to interact with the system 300 and invoke the Push-to-Scan service. An example of such a user interface UI is described herein with reference to FIG. 4.

The Request-based service layer 304 manages various user requests and functions as a session manager. In one embodiment, the Request-based service layer 304 controls the barcode scanner driver 306 to generate a decoded output signal from a data capture device. In general, the Request-based service layer 304 integrates the transport logic (over RTP), scanner decoding (barcode driver) 306, keypad driver 308, user inputs through the UI (Multicast Push-to-Scan application) 302 and output/input from the server that manages data logic between various devices (Fused Scan+Voice service).

The next layer is a Fused Scan+Voice Service layer 310. The Fused Scan+Voice Service layer 310 allows background multicast interaction between devices in response to a user query. In one embodiment, the Fused Scan+Voice Service layer 310 is adapted to function independently upon receiving a user query.

More specifically, the Request-based service layer component 304 manages input from the user interface (UI) application 302 and coordinates the output from the barcode scanner driver 306 and keypad driver 308. Additionally, the Request-based service layer component 304 creates the query for the Fused Scan+Voice (FSV) service layer 310 and sends the query to the FSV service layer 310 with a unique identifier (ID). The Request-based service layer component 304 uses this unique ID to create a session for each user request/query/submission until a successful response is returned from the FSV service layer 310. Once the successful response is received from the FSV service layer 310, the Request-based service layer component 304 forwards the response to the UI application 302 and then closes the particular session. In one embodiment, the session includes both data for the scanned barcode and VoIP traffic. The Request-based service layer component 304 closes the session in response to the successful transmission of the barcode data over the VoIP network.

In one embodiment, the Request-based service layer component 304 manages and establishes data exchange between different devices using multicast or when desired uni-cast messaging protocols. The Request-based service layer component 304 can operate in two modes.

The first mode is the unsupervised mode. The unsupervised mode is used when a user initiates a barcode query for information retrieval. The FSV service layer 310 integrates the query into a Real-Time Transport Protocol (RTP) packet and dispatches the query to another device. The FSV service layer 310 in the other device containing the requested information responds to the requesting device. In one embodiment, the FSV service layer 310 receives the information and stores the information in a local storage device 312. The information is then transmitted to the Request-based service layer component 304.

In an embodiment in which the FSV service layer 310 receives a similar request from another device's FSV service layer, the other device's FSV service layer 310 first searches its device's local database. If the information is available in the local database, the other device's FSV service layer transmits the information to the FSV service layer 310 of the requesting device. The information exchange can occur at the FSV service layer 310 without user intervention.

The logic of handling the information exchange is contained in the Request-based service layer component 304 which communicates with a RTP module 314 and the local storage device 312 through a request engine 316. The RTP module 314 also interacts with a wireless driver 318 for controlling the radio transceiver of the device. The Request-based service layer component 304 transfers control to the FSV service layer 310 once the requested information is received.

The second mode is the supervised mode. The supervised mode is used when the FSV service layer 310 is handling direct user queries within a session. The Request-based service layer component 304 is operated in a supervised mode and no logic is used. The primary focus of the supervised mode of operation is handling the user request directly.

In one embodiment, the supervised mode is used, for example, when a user selects a function of the device that can be locally completed, such as modifying a configuration of the device. The supervised mode can also be used when a user initiates a uni-cast call with a second device from which it received a query.

FIG. 4 illustrates a graphical user interface (GUI) 400 for a Push-to-Scan application according to one embodiment of the invention. For example, the GUI 400 can be displayed on the display 108 (FIG. 1). It should be noted that the GUI 400 can have any suitable design.

In one embodiment, the GUI 400 includes two main sections 402, 404. The first section 402 includes icons and the second section 404 displays data resulting from the selected icon, for example. The icons in the first section 402 include Push-to-Share 406, Quick information 408, Update information 410, Work order 412, Inventory check 414, Punch In/Out 416, Data manager 418, and Configuration 420. The GUI 400 can include fewer icons or more icons depending on the desired functionality of the Push-to-Scan function. Moreover, the icons shown in FIG. 4 are merely exemplary, other icons providing different functionality can also be used.

The icons in the first section 402 enable specific functionality that is activated by selecting the icon and pressing the PTS (Push-to-Scan) control 110 on the mobile device 100 (FIG. 1). This activates the Request-Based Service application 304 (FIG. 3).

The second section 404 displays the response from the Request-Based service application 304. For example, selecting the Quick information 408 icon in the first section 402 results in the retrieval of basic information for a stool displayed the second section 404 of the display 108. In one embodiment, a picture and a brief description is displayed in the second section 404. A Full-screen mode icon 422 can provide the user with optional display settings, such as expanding the second section 404 into the first section 402. This expansion can permit the user to read more information or show more details to a customer.

The following descriptions are for illustration only. In practice, the icons can include the different functionality. Additional icons (not shown) can also be included. In one embodiment, a specific icon on the GUI 400 is initially selected and then the Push-to-Scan control 110 is activated to initiate the Request-based Service Application 304. In an alternate embodiment, the Push-to-Scan control 110 is initially activated and then a specific icon on the GUI 400 is selected to initiate the Request-based Service Application 304.

The Push-to-Share icon 406 is used in a multicast scenario to transmit the barcode/RFID tag information to a group of networked devices. In one embodiment, the user of the mobile device 100 can activate the Push-to-Scan control 110 to request additional information from the group of networked devices about a selected product. Other devices in the group having the information can respond to the mobile device 100 during the same Push-to-Scan session.

The Quick information icon 408 displays information about a selected product. For example, the information can include one or more pictures, video, audio, or text used to describe a product.

The Update information icon 410 is used to update information about the product. In one embodiment, selecting the Update information icon 410 introduces an input window (not shown) which allows the user to incorporate the updated information. In one embodiment, the input window supports, text, images, audio and video. Once the data is inputted into the input window and the Push-to-Scan control 110 is activated, the updated information is appended to the information already stored in the database.

The Work order icon 412 automatically transmits the data/price of a selected product to a pre-selected cash register for checkout. In one embodiment, the Work order icon 412 requests that the user (store employee) of the mobile device enter basic information about the customer. This can facilitate efficient check out, because items checked-out by the customer can be instantly retrieved at the cash register. The customer can approach the cash register for check-out and simply provide the customer's name/ID. The cash register device automatically retrieves the information and accepts payment from the customer.

The Inventory check icon 414 can be used by an employee to check if a product is available in inventory. In one embodiment, the selection of the Inventory check icon 414 can be followed by activating the Push-to-Scan control 110. In one embodiment, the mobile device 100 can automatically send a voice dispatch to the warehouse. The employee can request information from a warehouse employee and/or request retrieval of the requested product or service.

The Punch In/Out icon 416 can be used by an employee to check in and out when the employee arrives/departs. In one embodiment, selecting the Punch In/Out icon 416 and then activating the Push-to-Scan control 110 can transmit the check in/check out information to a supervisor's device. The supervisor can track the whereabouts of each employee in the warehouse, for example. The check in/check out information can also be sent to a server device for further processing.

The Data manager icon 418 can be enabled on supervisor level devices and can provide any desired functionality. For example, selecting the Data manager icon 418 can allow a supervisor to store product information in a database stored locally on the supervisor's device. In one embodiment, the Data manager icon 418 can be removed from non-supervisor level devices

The Configuration icon 420 can be enabled on supervisor level devices. Selecting the Configuration icon 420 provides functionality to allow the supervisor to configure other devices on the network. In one embodiment, the Configuration icon 420 can be removed from non-supervisor level devices.

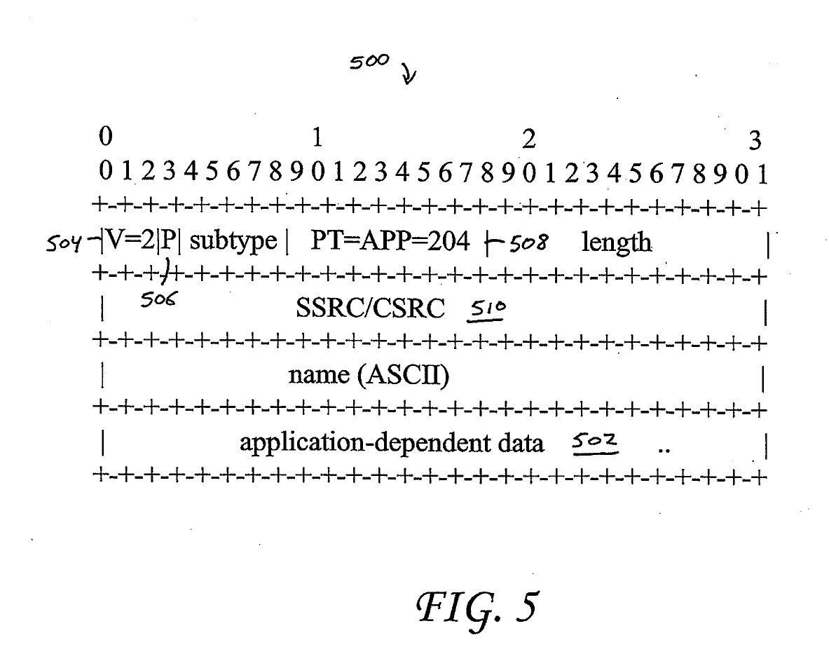

FIG. 5 illustrates an application-defined Real-time Control protocol (RTCP) APP message 500 according to one embodiment of the invention. A Real-time transport protocol (RTP) is used for transmitting real-time data, audio, video or uni-cast/multicast network services. However, the data transport mechanism is augmented by the control protocol (RTCP) to provide monitoring of the data delivery.

In one embodiment, for non-audio data, the application-defined APP message type 500 is used to send the non-audio data M events between devices. An Application-dependent data field 502 carries a particular M event and the receiving party decodes the RTCP App message 500 to read the received M event.

The application-defined Real-time Control protocol (RTCP) APP message 500 includes the following fields: Version (V) 504 is set to a value of 2 for the Push-to-Scan function. This represents the standard value for this field in many implementations of RTP. The next field is P 506, which indicates the padding. This bit is set to zero. The payload type (PT) field 508 is set to 204 (decimal) for Push-to-Scan function. The next field is the synchronization source (SSRC) identifier/contributing source (CSRC) identifier 510. The SSRC field 510 is used to identify Push-to-Scan sessions.

The application-dependent data field 502 has a length of 32 bits or multiples of 32 bits. This field 502 describes the message format used by the Push-to-Scan application for data exchange. The field 502 is broken into two sections. The first 32 bits include the control fields and the remaining bits represent the actual data string.

For example, the first 32 bit section contains Push-to-Scan session control information. It consists of 2 subfields: The first subfield is the Push-to-Scan session control field. This subfield is 16 bits in length and is divided as follows:
Bit 0 indicates that the query request originated from the user. This bit will stay set until the initiator receives a satisfactory response for its query and clears the bit.
Bits 1 through 4 indicate the type of query. This subfield provides direct support for sixteen different types of queries.
Bits 5 and 6 are reserved.
Bits 7 through 15 contain the unique ID of the query initiating device. This subfield provides support for 512 devices for operation under one network.

The second subfield contains an optional text string. This subfield is 8 bits in length. It contains the actual length of the data string in bytes. The remaining bits contain the barcode decoded data or result data for a query response.

It should be noted that for voice traffic, a standard RTP packet is used to send voice data directly between the two devices. Each device is identified by its unique ID. Skilled artisans will understand the technical details of standard RTP message relating to uni-cast and multicast voice traffic and those details will not be discussed herein. The RTCP packet 500 described above uses the same transport used for regular VoIP data, thereby eliminating any separate infrastructure or software for deploying wireless scanning services.

The Push-to-Scan architecture also manages multi-cast VoIP. In one embodiment, if a user directly activates the Push-to-Scan control switch 110 (FIG. 1) without selecting a particular Push-to-Scan icon from the GUI 400, the system can send a standard multicast VoIP telecast using a standard RTP packet transfer. If user selects an icon from the GUI 400, and then activates the Push-to-Scan control switch 100, the Real-time Control protocol (RTCP) described with reference to FIG. 5 is used for packet transfer.

Thus, the Push-to-Scan architecture of the invention seamlessly integrates standard RTP packet transfer and Real-time Control protocol (RTCP) packet transfer. For example, in one embodiment, a user can initiate a VoIP call, while the FSV service layer 310 (FIG. 3) is simultaneously collecting any required data.

In general, the processor includes processing logic configured to carry out the functions, techniques, and processing tasks associated with the operation of the mobile device. Furthermore, the steps of a method or algorithm described in connection with the embodiments disclosed herein may be embodied directly in hardware, in firmware, in a software module executed by the processor, or any combination thereof. Any such software may be implemented as low level instructions (assembly code, machine code, etc.) or as higher-level interpreted or compiled software code (e.g., C, C++, Objective-C, Java, Python, etc.).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus described herein. The non-processor circuits may include, but are not limited to, a radio receiver, a radio transmitter, signal drivers, clock circuits, power source circuits, and user input devices. As such, these functions may be interpreted as steps of a method to perform the Push-to-Scan functions described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts or steps is intended to be required unless specifically indicated.

What is claimed is:

1. A mobile device, comprising:
a control for activating a function of the mobile device, the function comprising at least one of a Push-to-Talk function and a Push-to-Scan function of the mobile device;
a processor coupled to the control, the processor executing the function when the control is activated;
a transceiver coupled to the processor, the transceiver capable of communicating with at least one networked device over a local area network using voice over internet protocol (VoIP); and
a memory coupled to the processor for storing instructions to execute the function by the processor, the processor executing the Push-to-Talk function in a first mode of operation and the Push-to-Scan function in a second mode of operation.

2. The mobile device of claim 1, further comprising a speaker and a microphone for enabling the Push-to-Talk function.

3. The mobile device of claim 1, further comprising a data capture device for enabling the Push-to-Scan function.

4. The mobile device of claim 3, wherein the data capture device comprises at least one of a barcode scanner, an imaging device, and a radio-frequency identification (RFID) reader.

5. The mobile device of claim 1, further comprising a display coupled to the processor for displaying a graphical user interface (GUI).

6. The mobile device of claim 1, wherein the memory further comprises a database for storing product information.

7. The mobile device of claim 1, wherein the Push-to-Talk function comprises communicating audio data between the mobile device and at least one networked device.

8. The mobile device of claim 1, wherein the Push-to-Scan function comprises communicating product data between the mobile device and at least one networked device.

9. The mobile device of claim 1, wherein the Push-to-Scan function comprises communicating product data between one and many the mobile devices.

10. The mobile device of claim 1, wherein the instructions comprise a request based service application executed in response to activating a function of the mobile device.

11. The mobile device of claim 10, wherein the request based service application creates a request for a fused scan and voice service application.

12. The mobile device of claim 11, wherein the request based service application is executed in response to activating a function of the mobile device.

13. The mobile device of claim 11, wherein the request based service application controls the Push-to-Talk function and the Push-to-Scan function.

14. A method, comprising:
storing instructions to execute a function of a mobile device, the function comprising at least one of a Push-to-Talk function and a Push-to-Scan function of the mobile device;
executing the Push-to-Talk function in a first mode of operation and the Push-to-Scan function in a second mode of operation; and
communicating data generated by executing the function with at least one networked device over a local area network using voice over internet protocol (VoIP).

15. The method of claim 14, wherein the data comprises one of audio data and product data.

16. The method of claim 15, wherein the data is generated by one of a barcode scanner, an imaging device, and a radio-frequency identification (RFID) reader.

17. The method of claim 14, further comprising displaying a graphical user interface (GUI).

18. The method of claim 14, further comprising storing product information.

19. The method of claim 14, wherein the Push-to-Talk function comprises communicating audio data between the mobile device and at least one other mobile device.

20. The method of claim 14, wherein the Push-to-Scan function comprises communicating product data between the mobile device and at least one other mobile device.

21. A mobile device comprising:
means for storing instructions to execute a function of the mobile device, the function comprising at least one of a Push-to-Talk function and a Push-to-Scan function of the mobile device;
means for executing the Push-to-Talk function in a first mode of operation and the Push-to-Scan function in a second mode of operation; and
means for communicating data generated by executing the function with at least one networked device over a local area network using voice over internet protocol (VoIP).
